(19) United States
(12) Patent Application Publication
(10) Pub. No.: US 2017/0339545 A1
(43) Pub. Date: Nov. 23, 2017

(54) METHOD AND APPARATUS FOR ACCESSING WIRELESS NETWORK

(71) Applicant: BEIJING XIAOMI MOBILE SOFTWARE CO., LTD, Beijing (CN)

(72) Inventors: Qiang FU, Beijing (CN); Shiquan Zhou, Beijing (CN); Enxing Hou, Beijing (CN)

(73) Assignee: BEIJING XIAOMI MOBILE SOFTWARE CO., LTD, Beijing (CN)

(21) Appl. No.: 15/360,450

(22) Filed: Nov. 23, 2016

(30) Foreign Application Priority Data
May 19, 2016 (CN) 201610338997.0

(51) Int. Cl. H04W 8/00; H04W 68/00; H04W 48/10

(52) U.S. Cl. CPC H04W 8/005; H04W 48/10; H04W 68/00

(57) ABSTRACT

The disclosure relates to a method and apparatus for accessing a wireless network. The method includes receiving, by a first device, a first broadcast message from a second device intending to access the wireless network; generating notification information based on the first broadcast message, wherein the notification information is configured to notify a user via the first device that the second device is requesting access to the wireless network; receiving an input from the user based on the notification information; and sending a request message to a wireless router in response to the input, wherein the request message is configured to instruct the wireless router to broadcast a second broadcast message including access information for accessing the wireless network via the wireless router.

### CROSS-REFERENCE TO RELATED APPLICATIONS

This application is based upon and claims priority to Chinese Patent Application No. 201610338997.0, filed May 19, 2016, the entire contents of which are incorporated herein by reference.

### TECHNICAL FIELD

The present disclosure generally relates to the technical field of wireless communications, and more particularly, to a method and apparatus for accessing a wireless network.

### BACKGROUND

With the popularization of the wireless network, Wireless Fidelity (WIFI) becomes more and more important.

### SUMMARY

This Summary is provided to introduce a selection of aspects of the present disclosure in a simplified form that are further described below in the Detailed Description. This Summary is not intended to identify key features or essential features of the claimed subject matter, nor is it intended to be used to limit the scope of the claimed subject matter.

Aspects of the present disclosure provide a method and apparatus for accessing a wireless network, so as to enable a WIFI device intending to access the wireless network, which lacks a valid input interface, to access the wireless network.

Aspects of the disclosure provide a method for accessing a wireless network. The method includes receiving, by a first device, a first broadcast message from a second device intending to access the wireless network; generating notification information based on the first broadcast message, wherein the notification information is configured to notify a user via the first device that the second device is requesting access to the wireless network; receiving an input from the user based on the notification information; and sending a request message to a wireless router in response to the input, wherein the request message is configured to instruct the wireless router to broadcast a second broadcast message including access information for accessing the wireless network via the wireless router.

The input is received on the first device via a physical keyboard or a touch screen. The first broadcast message indicates that the second device requires access to the wireless network.

The method also includes pushing out the notification information. Specifically, when the notification information is text notification information, the method includes displaying the text notification information; when the notification information is sound notification information, the method includes playing the sound notification information; when the notification information is light notification information, the method includes emitting a light signal; and when the notification information is vibration notification information, the method includes generating a vibration.

The method further includes determining whether the first device has access to the wireless router; and when the first device does not have access to the wireless router, controlling the first device to access the wireless router.

Aspects of the disclosure provide another method for accessing a wireless network. The method includes receiving, by a wireless router, a request message from a first device; generating a broadcast message in response to the request message, wherein the broadcast message includes access information for accessing the wireless network via the wireless router; and broadcasting the broadcast message on a plurality of frequency bands, wherein the broadcast message is configured to enable a second device intending to access the wireless network to access the wireless router based on the access information included in the broadcast message.

The method also includes determining a wireless operating frequency supported by the second device; and broadcasting the broadcast message on the plurality of frequency bands including the wireless operating frequency.

The method further includes receiving an access request message from the second device, wherein the access request message includes the access information; and assigning an IP address to the second device to enable the second device to access the wireless network based on the IP address.

Aspects of the disclosure also provide an apparatus for accessing a wireless network. The apparatus includes a processor and a memory configured to store instructions executable by the processor. The processor is configured to receive, by a first device, a first broadcast message from a second device intending to access the wireless network; generate notification information based on the first broadcast message, wherein the notification information is configured to notify a user via the first device that the second device is requesting access to the wireless network; receive an input from the user based on the notification information; and send a request message to a wireless router in response to the input, wherein the request message is configured to instruct the wireless router to broadcast a second broadcast message including access information for accessing the wireless network via the wireless router.

The processor is also configured to receive the input via a physical keyboard or a touch screen. The first broadcast message indicates that the second device requires access to the wireless network, and the processor is configured to push out the notification information. Specifically, when the notification information is text notification information, the processor is configured to display the text notification information; when the notification information is sound notification information, the processor is configured to play the sound notification information; when the notification information is light notification information, the processor is configured to emit a light signal; and when the notification information is vibration notification information, the processor is configured to generate a vibration.

The processor is also configured to determine whether the first device has access to the wireless router; and when the first mobile device does not have access to the wireless router, control the first device to access the wireless router.

Aspects of the disclosure also provide another apparatus for accessing a wireless network. The apparatus includes a processor and a memory configured to store instructions executable by the processor. The processor is configured to receive, by a wireless router, a request message from a first device; generate a broadcast message in response to the request message, wherein the broadcast message includes access information for accessing the wireless network via the wireless router; and broadcast the broadcast message on a plurality of frequency bands, wherein the broadcast message is configured to enable a second device intending to access the wireless network to access the wireless router based on the access information included in the broadcast message.

The processor is also configured to determine a wireless operating frequency supported by the second device; and broadcast the broadcast message on the plurality of frequency bands including the wireless operating frequency.

The processor is also configured to receive an access request message from the second device, wherein the access request message includes the access information; and assign an IP address to the second device to enable the second device to access the wireless network based on the IP address.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate aspects consistent with the disclosure and, together with the description, serve to explain the principles of the disclosure.

FIG. 1A is a flow chart showing a method for accessing a wireless network, according to an exemplary aspect of the present disclosure.

FIG. 1B is an application scenarios view of a method for accessing a wireless network, according to an exemplary aspect of the present disclosure.

FIG. 2A is a flow chart showing a method for accessing a wireless network, according to a first exemplary aspect of the present disclosure.

FIG. 2B is a flow chart showing that a mobile device accesses a wireless router, according to a first exemplary aspect of the present disclosure.

FIG. 3 is a flow chart showing a method for accessing a wireless network, according to a second exemplary aspect of the present disclosure.

FIG. 4 is a flow chart showing a method for accessing a wireless network, according to a third exemplary aspect of the present disclosure.

FIG. 5 is a block diagram illustrating an apparatus for accessing a wireless network, according to an exemplary aspect of the present disclosure.

FIG. 6 is a block diagram illustrating another apparatus for accessing a wireless network, according to an exemplary aspect of the present disclosure.

FIG. 7 is a block diagram illustrating further another apparatus for accessing a wireless network, according to an exemplary aspect of the present disclosure.

FIG. 8 is a block diagram illustrating still another apparatus for accessing a wireless network, according to an exemplary aspect of the present disclosure.

FIG. 9 is a block diagram illustrating an apparatus adapted for accessing a wireless network, according to an exemplary aspect of the present disclosure.

The specific aspects of the present disclosure, which have been illustrated by the accompanying drawings described above, will be described in detail below. These accompanying drawings and description are not intended to limit the scope of the present disclosure in any manner, but to explain the concept of the present disclosure to those skilled in the art via referencing specific aspects.

### DETAILED DESCRIPTION

Reference will now be made in detail to exemplary aspects, examples of which are illustrated in the accompanying drawings. The following description refers to the accompanying drawings in which the same numbers in different drawings represent the same or similar elements unless otherwise represented. The implementations set forth in the following description of exemplary aspects do not represent all implementations consistent with the disclosure. Instead, they are merely examples of apparatuses and methods consistent with aspects related to the disclosure as recited in the appended claims.

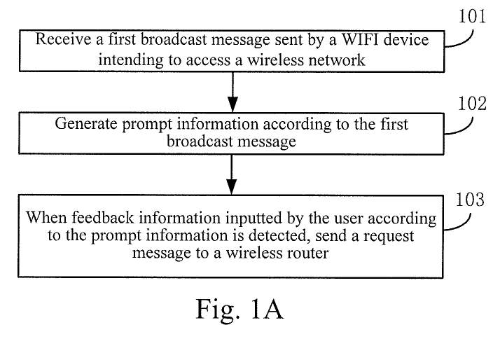

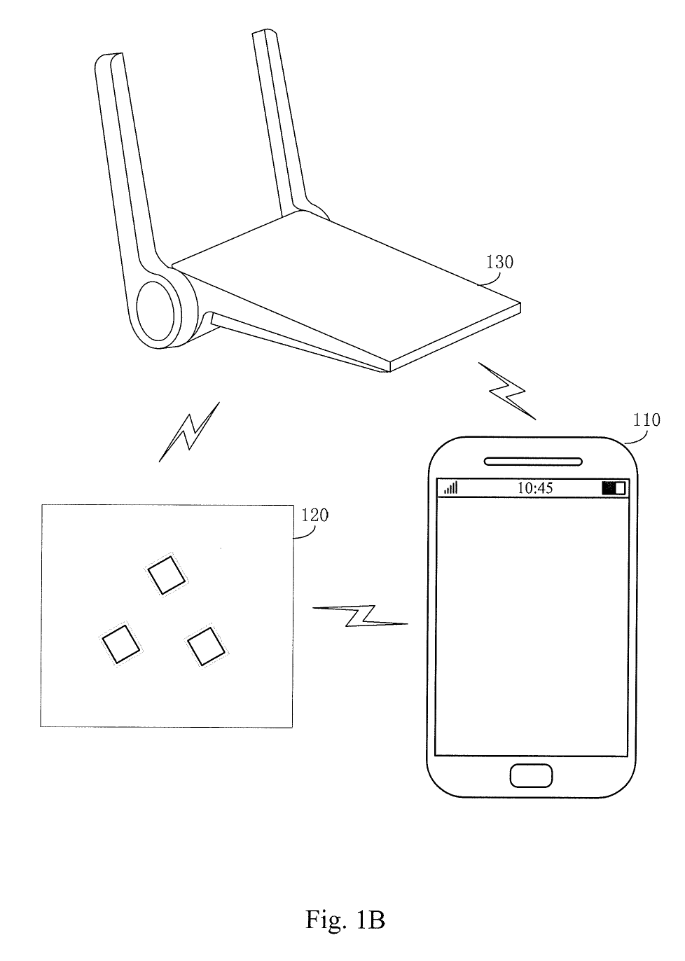

FIG. 1A is a flow chart showing a method for accessing a wireless network, according to an exemplary aspect. FIG. 1B is an application scenarios view of a method for accessing a wireless network, according to an exemplary aspect. The method for accessing a wireless network may be applied in a mobile device (such as a smart phone, and a tablet computer). As shown in FIG. 1A, the method for accessing a wireless network may include the following steps.

In step 101, a first broadcast message sent by a WIFI device intending to access a wireless network (WIFI device) is received.

In an aspect, the WIFI device may send the first broadcast message via a built-in WIFI chip.

In an aspect, the WIFI device may be a smart socket, a smart bulb, and the like.

In an aspect, the WIFI device may only support one operating frequency band, or may support more than one operating frequency bands.

In step 102, prompt information (e.g., notification information) is generated according to the first broadcast message.

In an aspect, the prompt information is configured for prompting (e.g., notifying) a user that the WIFI device requests to access the wireless network.

In an aspect, the prompt information may be text prompt information; in another aspect, the prompt information may be sound prompt information; in further another aspect, the prompt information may be light prompt information; in still another aspect, the prompt information may be vibration prompt information; in still further another aspect, the prompt information may be prompt information of a combination of any two or more of the text prompt information, the sound prompt information, the light prompt information, and the vibration prompt information.

In step 103, when feedback information inputted by the user according to the prompt information is detected, a request message is sent to a wireless router.

In an aspect, the request message is configured for instructing the wireless router to broadcast a second broadcast message carrying preset accessing information.

In an aspect, the preset accessing information may be a Service Set Identifier (SSID) of the wireless router and a user password for accessing the wireless router. For example, the SSID is guangbo, and the user password is 1368316.

As shown in FIG. 1B, an illustrative explanation will be given by using a smart switch, such as the WIFI device 120 (e.g., second device), intending to access the wireless network. When receiving a first broadcast message sent by the WIFI device 120, the mobile device 110 (e.g., first device) may determine a wireless router 130 which the WIFI device 120 wants to access according to an operation triggered by the user, and send a request message to the wireless router 130 to request the wireless router 130 to send a second broadcast message carrying preset accessing information therein, such as the SSID and the user password of the wireless router, then the wireless router 130 may send a second broadcast message based on all the compatible operating frequency bands, thereby the WIFI device 120 may receive the second broadcast message of the operating frequency band compatible by the WIFI device 120 itself, and then request to access the wireless router 130 according to the preset accessing information.

In the present aspect, after receiving a first broadcast message sent by a WIFI chip built in the WIFI device, the mobile device may generate prompt information for prompting the user that the WIFI device wants to access the wireless network at present. If feedback information inputted by the user according to the prompt information is detected, the mobile device may send a request message to the wireless router to request the wireless router to send a second broadcast message carrying preset accessing information, such that the WIFI device can access the wireless network with the help of the mobile device, and the problem that the WIFI device lacking a valid input interface cannot access a designated wireless router is avoided.

In an aspect, the method may further include: receiving an operation triggered by the user via a physical keyboard according to the prompt information, or an operation triggered on a user interface of the mobile device via a touch screen; and generating feedback information according to the operation.

In an aspect, generating the prompt information according to the first broadcast message may include: when the first broadcast message indicates that the WIFI device needs to access the wireless network, generating the prompt information; and pushing out the prompt information.

In an aspect, pushing out the prompt information may include: if the prompt information is text prompt information, displaying the prompt information; if the prompt information is sound prompt information, playing the sound prompt information; if the prompt information is light prompt information, emitting a light signal of a preset type; and if the prompt information is vibration prompt information, issuing a vibration instruction according to a preset frequency.

In an aspect, the method may further include: controlling the mobile device to access the wireless router, and performing the step of sending the request message to the wireless router.

As to how to access the wireless network, the following aspects may be referred to.

So far, the above-mentioned methods provided by the aspects of the present disclosure may enable the mobile device to help the WIFI device lacking a valid input interface to access a designated wireless router, and optimize the user experience.

Hereinafter, the technical solutions provided by the aspects of the present disclosure will be explained by using the aspects.

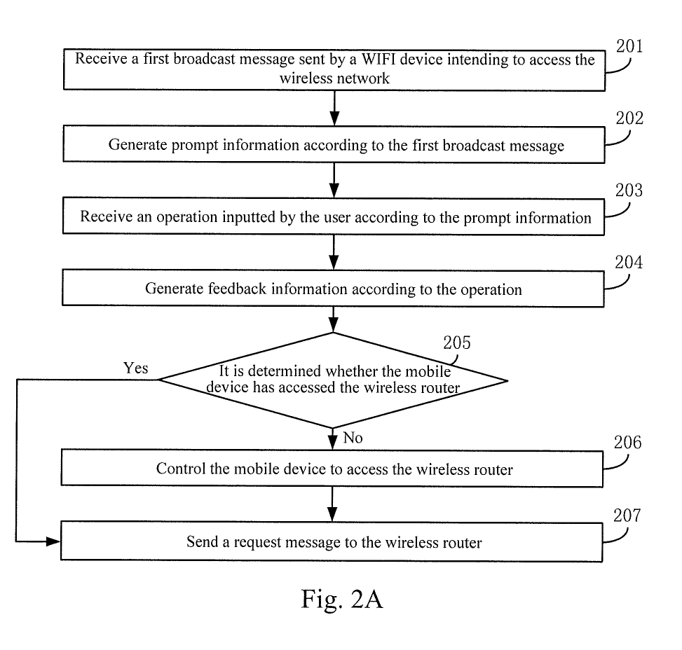

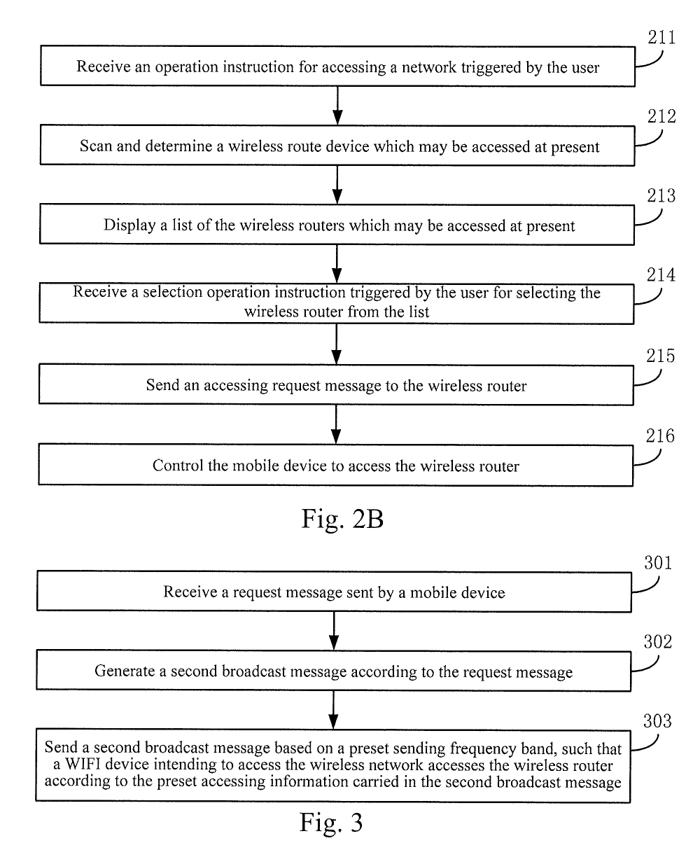

FIG. 2A is a flow chart showing a method for accessing a wireless network, according to a first exemplary aspect, and FIG. 2B is a flow chart showing that a mobile device accesses a wireless router, according to a first exemplary aspect. The present aspect utilizes the above-mentioned method provided by the aspects of the present disclosure, and the illustrative explanations are given by using an example in which the mobile device assists the WIFI device only supporting 2.4G frequency band to access the wireless router compatible with 2.4G and 5G operating frequency bands. As shown in FIG. 2A, the method may include the following steps.

In step 201, a first broadcast message sent by a WIFI device intending to access the wireless network is received.

The related description of the step 201 may refer to the description of the step 101 in the aspect shown in FIG. 1A.

In step 202, prompt information is generated according to the first broadcast message.

In an aspect, the prompt information is configured for prompting a user that the WIFI device requests to access the wireless network.

In an aspect, when the prompt information is text prompt information, the prompt information is displayed, for example, text information “The smart bulb is not connected to a wireless network yet, please determine whether to assist the smart bulb to connect to the wireless network.” may be displayed on a display interface; when the prompt information is sound prompt information, the sound prompt information may be played, for example, text voice information may be played, or a music prompt voice may be played; when the prompt information is light prompt information, a light signal of a preset type is emitted, for example, a bright light signal is emitted, or a flashing light signal is emitted; when the prompt information is vibration prompt information, a vibration instruction is issued according to a preset frequency, for example, a vibration is issued for 1 second every 0.5 second, or a vibration is issued for 2 seconds every 1 second.

In step 203, an operation inputted by the user according to the prompt information is received.

In an aspect, the mobile device may receive an operation triggered by the user via a physical keyboard.

In another aspect, the mobile device may receive an operation triggered on a user interface of the mobile device via a touch screen by the user.

In step 204, feedback information is generated according to the operation.

After receiving the operation triggered by the user, the mobile device may generate corresponding feedback information, for example, the user interface of the mobile device displays prompt information “The smart bulb is not connected to a wireless network yet, please determine whether to assist the smart bulb to connect to the wireless network.” When it is detected that the user clicks a “YES” button via a touch screen, the mobile device may generate feedback information “Assist the smart device to access the wireless network” according to the operation of clicking the “YES” button by the user.

In step 205, it is determined whether the mobile device has accessed the wireless router, if the mobile device has not accessed the wireless router, step 206 is performed; and if the mobile device has accessed the wireless router, step 207 is performed.

In the step 206, the mobile device is controlled to access the wireless router, and then the step 207 is performed.

In an aspect, the detailed description of the step 206 may refer to FIG. 2B. As shown in FIG. 2B, the step may include the following steps.

In step 211, an operation instruction for accessing a network triggered by the user is received.

In step 212, a wireless route device which may be accessed at present is scanned and determined.

In step 213, a list of the wireless router which may be accessed at present is displayed.

In step 214, a selection operation instruction triggered by the user for selecting the wireless router from the list is received.

In an aspect, the wireless route device displayed in the list may include the wireless route device within a preset distance from the mobile device, and the user may select the wireless router which the WIFI device may access.

In step 215, an accessing request message is sent to the wireless router.

In an aspect, the accessing request message carries therein preset accessing information.

In an aspect, the preset accessing information may include a SSID number and a user password of the wireless router.

In step 216, the wireless router is accessed according to an IP address assigned by the wireless router.

In an aspect, after receiving the accessing request message sent by the mobile device, if it is determined that the preset accessing information is correct, the wireless router may assign an IP address in an IP address pool to the mobile device, and then the mobile device may access the wireless router according to the IP address.

In step 207, a request message is sent to the wireless router.

In an aspect, the request message is configured for instructing the wireless router to broadcast a second broadcast message carrying preset accessing information.

On the basis of the advantageous effects of the above aspects, in the present aspect, the prompt information generated by the mobile device after receiving the first broadcast message sent by the WIFI chip built in the WIFI device may be prompt information of a combination of any one or more of text prompt information, sound prompt information, light prompt information, and vibration prompt information, such that the user may handle the prompt information timely, thereby improving the efficiency of accessing the wireless network by the WIFI device, and optimizing the user experience.

FIG. 3 is a flow chart showing a method for accessing a wireless network, according to a second exemplary aspect. This aspect may be applied in a wireless router, and the wireless router may be a mono-band router, or a dual-band router, or a multi-band router. In the present aspect, combining with the application scenario of FIG. 1B, the illustrative explanations are given by using an example that the WIFI device accesses a wireless router. As shown in FIG. 3, the method includes the following steps.

In step 301, a request message sent by a mobile device is received.

In an aspect, the request message is configured for instructing the wireless router to broadcast a second broadcast message carrying therein preset accessing information.

In step 302, a second broadcast message is generated according to the request message.

In an aspect, the second broadcast message carries therein preset accessing information.

In an aspect, the preset accessing information may be a Service Set Identifier (SSID) of the wireless router and a user password for accessing the wireless router. For example, the SSID is guangbo, and the user password is 1368316.

In step 303, a second broadcast message is sent based on a preset sending frequency band, such that a WIFI device intending to access the wireless network accesses the wireless router according to the preset accessing information carried in the second broadcast message.

In an aspect, after generating the second broadcast message, the wireless router may send the second broadcast message based on all the operating frequency bands compatible by the wireless router itself, and various WIFI devices may access the wireless router according to the received broadcast message.

For example, most of low-end WIFI devices only support 2.4G operating frequency band currently. If the operating frequency bands compatible by the dual-band router include a 2.4G operating frequency band and a 5G operating frequency band, then the wireless router may send the second broadcast message based on the 2.4G operating frequency band and the 5G operating frequency band at the same time, the WIFI device only supporting the 2.4G operating frequency band may receive the broadcast message sent by the wireless router based on the 2.4G operating frequency band, the WIFI device only supporting the 5G operating frequency band may receive the broadcast message sent by the wireless router based on the 5G operating frequency band, and the WIFI device compatible with the 2.4G operating frequency band and the 5G operating frequency band may randomly receive the broadcast message sent by the wireless router based on the 5G operating frequency band. Thereby, if the operating frequency band of the WIFI device is contained in the operating frequency band compatible by the wireless router, the WIFI device may receive the message broadcasted by the wireless router, and then access the wireless router.

As shown in FIG. 1B, after receiving a request message sent by the mobile device 110, the wireless router 130 may generate a second broadcast message, and send the second broadcast message based on all the compatible operating frequency bands. If the operating frequency band of the WIFI device 120 is contained in the operating frequency bands compatible by the wireless router 130, the WIFI device 120 may receive the second broadcast message sent by the wireless router 130, and then request to access the wireless router 130 according to preset accessing information.

In the present aspect, the wireless router may send the second broadcast message based on the preset sending frequency band, which solves the problem that the WIFI device only operating at one frequency band may not receive the broadcast message sent by the dual-band router, and thus cannot access the wireless router.

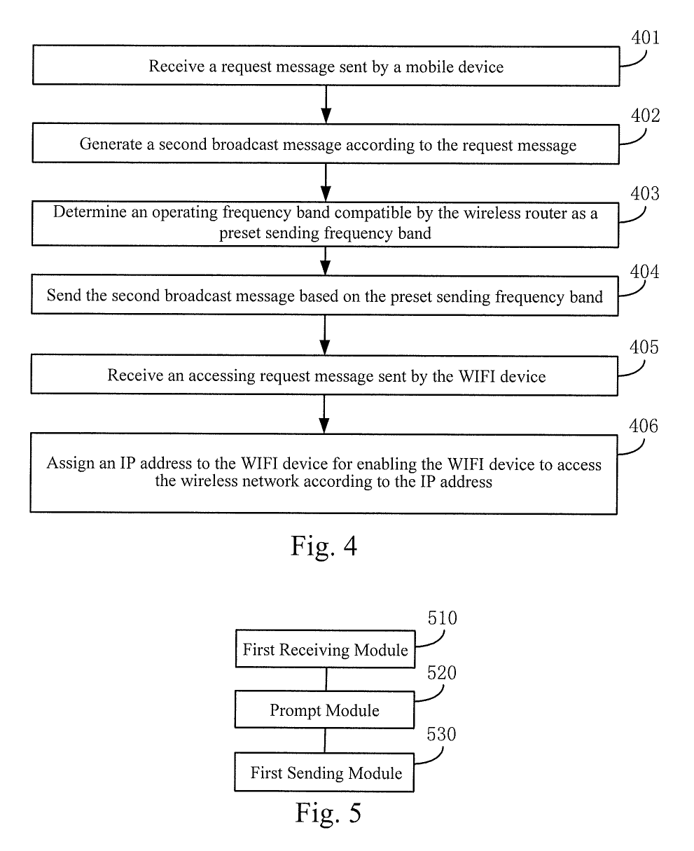

FIG. 4 is a flow chart showing a method for accessing a wireless network, according to a third exemplary aspect. In the present aspect, the above methods provided by the aspects of the present disclosure may be utilized, and the illustrative explanations are given by using an example in which the wireless router sends a second broadcast message to make the WIFI device access the wireless router. As shown in FIG. 4, the method includes the following steps.

In step 401, a request message sent by a mobile device is received.

In step 402, a second broadcast message is generated according to the request message.

In an aspect, the second broadcast message carries therein preset accessing information for accessing the wireless router.

In step 403, an operating frequency band compatible by the wireless router is determined as a preset sending frequency band.

For example, if the wireless router is compatible with a 2.4G operating frequency band and a 5G operating frequency band, then the preset sending frequency band includes the 2.4G operating frequency band and the 5G operating frequency band.

In step 404, the second broadcast message is sent based on the preset sending frequency band.

In an aspect, if the wireless router is compatible with the 2.4G operating frequency band and the 5G operating frequency band, then the second broadcast message may be sent based on the 2.4G operating frequency band and the 5G operating frequency band at the same time, and the preset accessing information carried in the broadcast message are the same. For example, the SSID is guangbo, and the user password is 1368316.

In step 405, an accessing request message sent by the WIFI device is received.

In an aspect, after receiving the second broadcast message sent by the wireless router, the WIFI device parses the message and sends an accessing request message to the wireless router according to the preset accessing information carried in the broadcast message.

In step 406, an IP address is assigned to the WIFI device for enabling the WIFI device to access the wireless network according to the IP address.

In an aspect, if it is determined that the accessing request message sent by the WIFI device is matched with local preset accessing information, the wireless router may assign an IP address to the WIFI device, and then the WIFI device may access the wireless network according to the IP address.

In the present aspect, by determining the operating frequency band compatible by the wireless router as the preset sending frequency band, the wireless router can send the second broadcast message based on all the compatible operating frequency bands, thereby avoiding the problem that as for the WIFI device only supporting one operating frequency band, when the wireless router sends the second broadcast message only based on a sending frequency band different from the operating frequency band of the WIFI device, the WIFI device cannot access the wireless router.

Corresponding to the aspects of the above methods for accessing a wireless network, the present disclosure also provides aspects of an apparatus for accessing a wireless network.

FIG. 5 is a block diagram illustrating an apparatus for accessing a wireless network, according to an exemplary aspect, wherein the apparatus is applied in a mobile device. As shown in FIG. 5, the apparatus for accessing a wireless network includes: a first receiving module 510, a prompt module 520, and a first sending module 530.

The first receiving module 510 is configured to receive a first broadcast message sent by a WIFI device intending to access the wireless network.

The prompt module 520 is configured to generate prompt information according to the first broadcast message received by the first receiving module 510, wherein the prompt information is configured for prompting a user that the WIFI device requests to access the wireless network.

The first sending module 530 is configured to, if feedback information inputted by the user according to the prompt information generated by the prompt module 520 is detected, send a request message to a wireless router, wherein the request message is configured for instructing the wireless router to broadcast a second broadcast message carrying preset accessing information.

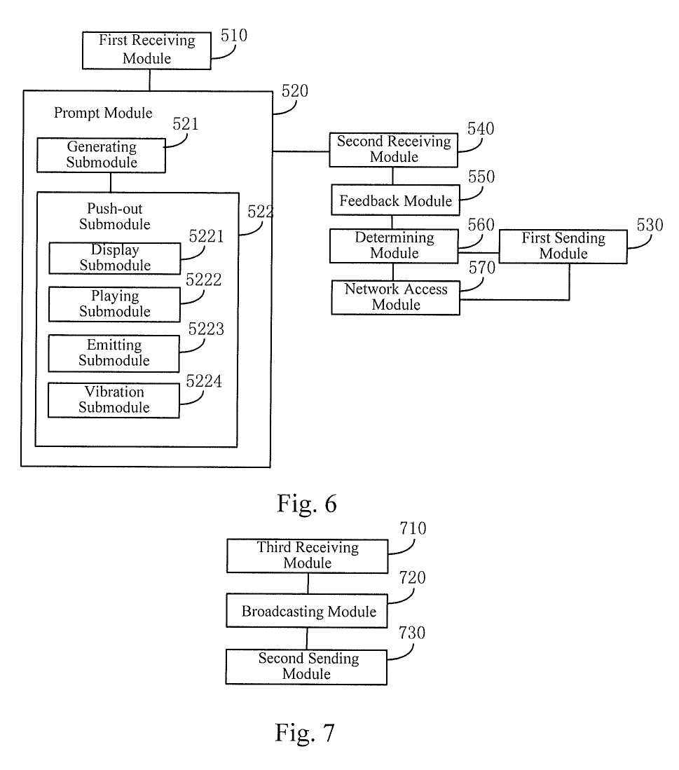

FIG. 6 is a block diagram illustrating another apparatus for accessing a wireless network, according to an exemplary aspect. As shown in FIG. 6, based on the aspect shown in FIG. 5, in an aspect, the apparatus may further include: a second receiving module 540, and a feedback module 550.

The second receiving module 540 is configured to receive an operation triggered by the user via a physical keyboard according to the prompt information, or an operation triggered on a user interface of the mobile device via a touch screen.

The feedback module 550 is configured to generate the feedback information according to the operation received by the second receiving module 540.

In an aspect, the prompt module 520 may include: a generating submodule 521, and a push-out submodule 522.

The generating submodule 521 is configured to, when the first broadcast message received by the first receiving module indicates that the WIFI device needs to access the wireless network, generate the prompt information.

The push-out submodule 522 is configured to push out the prompt information generated by the generating submodule 521.

In an aspect, the push-out submodule 522 may include: a display submodule 5221, a playing submodule 5222, an emitting submodule 5223, and a vibration submodule 5224.

The display submodule 5221 is configured to, if the prompt information generated by the generating submodule 521 is text prompt information, display the prompt information.

The playing submodule 5222 is configured to, if the prompt information generated by the generating submodule 521 is sound prompt information, play the sound prompt information.

The emitting submodule 5223 is configured to, if the prompt information generated by the generating submodule 521 is light prompt information, emit a light signal of a preset type.

The vibration submodule 5224 is configured to, if the prompt information generated by the generating submodule 521 is vibration prompt information, issue a vibration instruction according to a preset frequency.

In an aspect, the apparatus may further include: a determining module 560, and a network access module 570.

The determining module 560 is configured to determine whether the mobile device has accessed the wireless router.

The network access module 570 is configured to, if the determining module 560 determines that the mobile device has not accessed the wireless router, control the mobile device to access the wireless router, and the first sending module performs the step of sending the request message to the wireless router.

FIG. 7 is a block diagram illustrating further another apparatus for accessing a wireless network, according to an exemplary aspect. The apparatus is applied in a wireless router. As shown in FIG. 7, the apparatus for accessing a wireless network includes: a third receiving module 710, a broadcasting module 720, and a second sending module 730.

The third receiving module 710 is configured to receive a request message sent by a mobile device.

The broadcasting module 720 is configured to generate a second broadcast message according to the request message received by the third receiving module 710, wherein the second broadcast message carries therein preset accessing information for accessing the wireless router.

The second sending module 730 is configured to send the second broadcast message generated by the broadcasting module 720 based on a preset sending frequency band, such that a WIFI device intending to access the wireless network accesses the wireless router according to the preset accessing information carried in the second broadcast message, wherein more than two preset sending frequencies are located in different operating frequency bands.

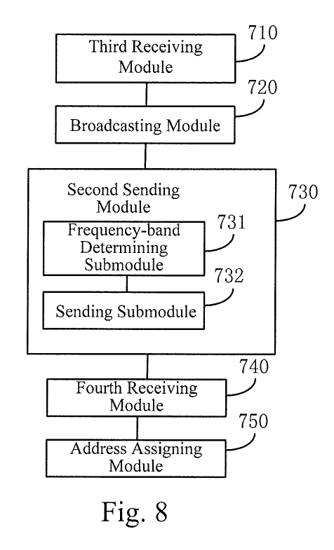

FIG. 8 is a block diagram illustrating still another apparatus for accessing a wireless network, according to an exemplary aspect. As shown in FIG. 8, on the basis of the above aspect shown in FIG. 7, in an aspect, the second sending module 730 may include: a frequency-band determining submodule 731, and a sending submodule 732.

The frequency-band determining submodule 731 is configured to determine an operating frequency band compatible by the wireless router as the preset sending frequency band.

The sending submodule 732 is configured to send the second broadcast message based on the preset sending frequency band determined by the frequency-band determining submodule 731.

In an aspect, the apparatus may further include: a fourth receiving module 740, and an address assigning module 750.

The fourth receiving module 740 is configured to receive an accessing request message sent by the WIFI device, wherein the accessing request message carries therein the preset accessing information carried in the second broadcast message generated by the broadcasting module.

The address assigning module 750 is configured to assign an IP address to the WIFI device for enabling the WIFI device to access the wireless network according to the IP address.

Implementation of the functions and operations of the units in the above devices can be specifically referred to the implementation of the corresponding steps in the above methods, which will not be elaborated herein.

For device aspects, since they are substantially corresponding to the method aspects, the relevant contents may be referred to some explanations in the method aspects. The above-described device aspects are only illustrative. The units illustrated as separate components may be or may not be separated physically, the component illustrated as a unit may be or may not be a physical unit, i.e., may be located at one location, or may be distributed into multiple network units. A part or all of the modules may be selected to achieve the purpose of the solution in the present disclosure according to actual requirements. The person skilled in the art can understand and implement the present disclosure without paying inventive labor.

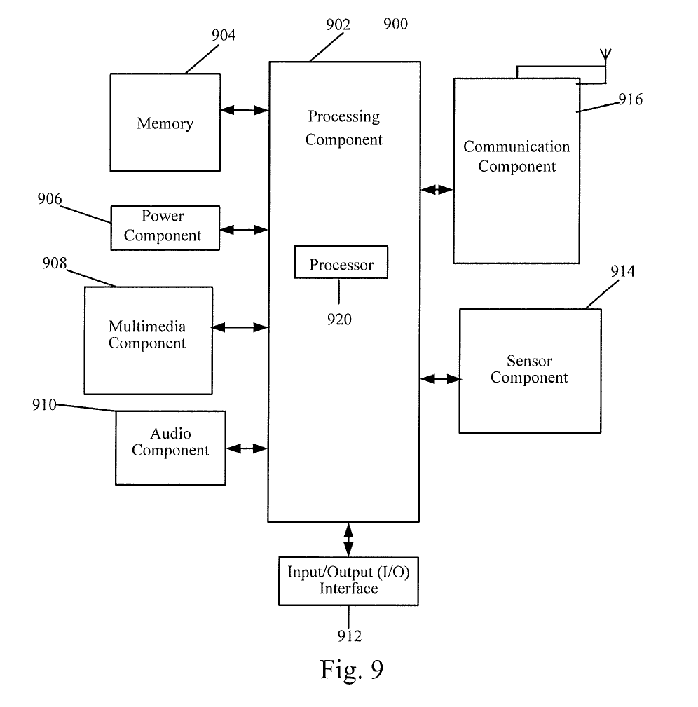

FIG. 9 is a block diagram illustrating an apparatus adapted for accessing a wireless network, according to an exemplary aspect. For example, the device 900 may be a mobile device, such as a mobile phone, and a tablet computer.

Referring to FIG. 9, the device 900 may include one or more of the following components: a processing component 902, a memory 904, a power component 906, a multimedia component 908, an audio component 910, an input/output (I/O) interface 912, a sensor component 914, and a communication component 916.

The processing component 902 typically controls overall operations of the device 900, such as the operations associated with display, telephone calls, data communications, camera operations, and recording operations. The processing component 902 may include one or more processors 920 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the device 900. Examples of such data include instructions for any applications or methods operated on the device 900, messages, pictures, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the device 900. The power component 906 may include a power management system, one or more power sources, and any other components associated with the generation, management, and distribution of power in the device 900.

The multimedia component 908 includes a screen providing an output interface between the device 900 and the user. In some aspects, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some aspects, the multimedia component 908 includes a front camera and/or a rear camera. The front camera and the rear camera may receive an external multimedia datum while the device 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone (“MIC”) configured to receive an external audio signal when the device 900 is in an operation mode, such as a call mode, a recording mode, and a voice recognition mode. The received audio signal may be further stored in the memory 904 or transmitted via the communication component 916. In some aspects, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the device 900. For instance, the sensor component 914 may detect an open/closed status of the device 900, relative positioning of components, e.g., the display and the keypad, of the device 900, a change in position of the device 900 or a component of the device 900, a presence or absence of user contact with the device 900, an orientation or an acceleration/deceleration of the device 900, and a change in temperature of the device 900. The sensor component 914 may include a proximity sensor configured to detect the presence of nearby objects without any physical contact. The sensor component 914 may also include a light sensor, such as a CMOS or CCD image sensor, for use in imaging applications. In some aspects, the sensor component 914 may also include an accelerometer sensor, a gyroscope sensor, a magnetic sensor, a distance sensor, a pressure sensor, or a temperature sensor.

The communication component 916 is configured to facilitate communication, wired or wirelessly, between the device 900 and other devices. The device 900 can access a wireless network based on a communication standard, such as WiFi, 2G, or 3G, or a combination thereof. In one exemplary aspect, the communication component 916 receives a broadcast signal or broadcast associated information from an external broadcast management system via a broadcast channel. In one exemplary aspect, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary aspects, the device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary aspects, there is also provided a non-transitory computer-readable storage medium including instructions, such as included in the memory 904, executable by the processor 920 in the device 900, for performing the above-described methods. For example, the non-transitory computer-readable storage medium may be a ROM, a RAM, a CD-ROM, a magnetic tape, a floppy disc, an optical data storage device, and the like.

The structure suitable for the wireless router may refer to the block diagram shown in FIG. 9 and the corresponding description, which are not elaborated herein.

It is noted that the various modules, sub-modules, units, and components in the present disclosure can be implemented using any suitable technology. For example, a module may be implemented using circuitry, such as an integrated circuit (IC). As another example, a module may be implemented as a processing circuit executing software instructions.

Other aspects of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for accessing a wireless network, the method comprising:
receiving, by a first device, a first broadcast message from a second device intending to access the wireless network;
generating notification information based on the first broadcast message, wherein the notification information is configured to notify a user via the first device that the second device is requesting access to the wireless network;
receiving an input from the user based on the notification information; and
sending a request message to a wireless router in response to the input, wherein the request message is configured to instruct the wireless router to broadcast a second broadcast message including access information for accessing the wireless network via the wireless router.

2. The method of claim 1, wherein the input is received on the first device via a physical keyboard or a touch screen.

3. The method of claim 1, wherein the first broadcast message indicates that the second device requires access to the wireless network, and wherein the method further comprises pushing out the notification information.

4. The method of claim 3, wherein the pushing out the notification information comprises:
when the notification information is text notification information, displaying the text notification information;
when the notification information is sound notification information, playing the sound notification information;
when the notification information is light notification information, emitting a light signal; and
when the notification information is vibration notification information, generating a vibration.

5. The method of claim 1, further comprising:
determining whether the first device has access to the wireless router; and
when the first device does not have access to the wireless router, controlling the first device to access the wireless router.

6. An apparatus for accessing a wireless network, the apparatus comprising:
a processor; and
a memory configured to store instructions executable by the processor, wherein the processor is configured to:
receive, by a first device, a first broadcast message from a second device intending to access the wireless network;
generate notification information based on the first broadcast message, wherein the notification information is configured to notify a user via the first device that the second device is requesting access to the wireless network;
receive an input from the user based on the notification information; and
send a request message to a wireless router in response to the input, wherein the request message is configured to instruct the wireless router to broadcast a second broadcast message including access information for accessing the wireless network via the wireless router.

7. The apparatus of claim 6, wherein the processor is further configured to receive the input via a physical keyboard or a touch screen.

8. The apparatus of claim 6, wherein the first broadcast message indicates that the second device requires access to the wireless network, and wherein the processor is further configured to push out the notification information.

9. The apparatus of claim 8, wherein the processor is further configured to:
when the notification information is text notification information, display the text notification information;
when the notification information is sound notification information, play the sound notification information;
when the notification information is light notification information, emit a light signal; and
when the notification information is vibration notification information, generate a vibration.

10. The apparatus of claim 6, wherein the processor is further configured to:
determine whether the first device has access to the wireless router; and
when the first mobile device does not have access to the wireless router, control the first device to access the wireless router.

11. An apparatus for accessing a wireless network, the apparatus comprising:
a processor; and
a memory configured to store instructions executable by the processor, wherein the processor is configured to:
receive, by a wireless router, a request message from a first device;
generate a broadcast message in response to the request message, wherein the broadcast message includes access information for accessing the wireless network via the wireless router; and
broadcast the broadcast message on a plurality of frequency bands, wherein the broadcast message is configured to enable a second device intending to access the wireless network to access the wireless router based on the access information included in the broadcast message.

12. The apparatus of claim 11, wherein the processor is further configured to:
determine a wireless operating frequency supported by the second device; and
broadcast the broadcast message on the plurality of frequency bands including the wireless operating frequency.

13. The apparatus of claim 11, wherein the processor is further configured to:
receive an access request message from the second device, wherein the access request message includes the access information; and
assign an IP address to the second device to enable the second device to access the wireless network based on the IP address.
